(19) United States
(12) Patent Application Publication
(10) Pub. No.: US 2005/0185635 A1
(43) Pub. Date: Aug. 25, 2005

(54) Virtual service provider system and method for delivering media services to an end user

(76) Inventor: C.L. Nagendra, Bangalore (IN)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/909,273

(22) Filed: Jul. 30, 2004

Related U.S. Application Data
(60) Provisional application No. 60/490,949, filed on Jul. 30, 2003.

(51) Int. Cl. H04L 12/66

(52) U.S. Cl. 370/352

(57) ABSTRACT

A virtual platform created on top of a existing physical infrastructure like public IP Network or Internet to transfer media content & services such as video, audio, images & voice from the content producer to content consumers. The Network begins to exist once broadcast source and one or content consumers connect. The content consumers use a Set top box Terminal which is connected to a IP Network/Broadband Internet connection used for local IP connectivity, the set top box accepts any physical IP/Internet Connection to provide Video, Audio & Data Output. The set top box in turn provides output to home electronics media/entertainment devices like TV/Audio System/Printer/Analog Telephone to enable various services from virtual service providers (who don't have own any last mile links) which include Virtual Radio/Audio Service Provider, Virtual TV Service Provider, Virtual PPV Service Provider, Virtual Telephone Service Provider Virtual Newspaper & Magazine Providers & more. This invention aggregates various media services to enable virtual service providers access to customer without actually owning dedicated last-mile links.

### CROSS-REFERENCE TO RELATED APPLICATIONS

This application claims priority to U.S. Provisional Patent Application No. 60/490,949, filed Jul. 30, 2003, which is incorporated herein by reference.

### BACKGROUND OF THE INVENTION

1. Field of the Invention

The present invention is related to systems and methods for creating a virtual network and, more particularly, to a system and method to enable virtual service providers to access end-users without having dedicated media-dependent last-mile physical infrastructure.

2. Background Information

Broadband internet access has become an integral part of the way in which content is delivered to personal computers users. For example, newspapers, magazines, and television and cable networks have web sites that are increasingly being used to deliver specialized content designed for browsers on Computers. Physical Broadband Connectivity has been provided by one of many residential broadband ISP which include, for example, service providers such as Speakeasy/SBC.

Using this common connectivity denominator (“broadband access”), various presently analog or media services could be piggy-backed on-top of a broadband connection in a transparent manner so that existing electronic appliances like Television/Radio/Music System/Telephone can be used with virtual service providers who may not actually have any sort of dedicated “last-mile” in place. Services such as Television, Radio, Music, Voice or Telephone can be virtualized and transported on top of existing last-mile infrastructure which has already been in place as physical broadband connectivity. Traditionally media services in audio, video & analog depend on dedicated transport mediums to deliver the service to the end-users. These services provide advantage to their service providers to hold a monopoly over the end-user they cover as the physically infrastructure is owned or licensed by the service provider.

Cable TV exists for a number of years. Television programs on cable are available in many areas. Such a typical arrangement can consist of a television set connected through a coaxial cable network to a cable television programs provider. The viewer can select through the television a particular program to be viewed. Upon selection of the particular channel, the channel's data is transferred from the cable tv provider, through the physical network, to the user's terminal, where it is displayed for the user. FIG. 1.a is a high-level network diagram illustrating the depicted simple prior art scenario wherein one TV set 14 connects (with user intervention) to one cable TV provider 10 for the selection and view of a given channels by the user.

FIG. 1.B is high-level network diagram of an analogous scenario wherein, using the Telephone Wire 18, an Telephone set 20 can receive & originate calls, using a telecom provider 16, who owns the physically infrastructure supporting the medium 18.

FIG. 2A shows how data is transmitted to the user's fax printer. FIG. 2B shows transmission of a radion program from a transmitter 28 over the airways 30 to a radio set 32.

FIG. 3.A high-level network diagram of an analogous scenario wherein, using the Internet 36, an special VoIP Phone terminal 38, such as for communication, from an specialized VoIP Provider 34.

FIG. 3.B is another high-level network diagram of an analogous scenario wherein, using the Internet 42, an Internet terminal 44 can select a program to be viewed, such as for example a sound file, from an Internet sound file provider 40, such as for example from Apple iTunes®. For doing so, the Internet user can click on the particular file's URL, and the file is downloaded and executed on the user's terminal 44. Additionally, the selected file can be transferred further onto, or in quasi-real-time to the music output system such as a portable music player. Typically, according to these prior art implementations, the user can only avail service of one given type from one given program provider, who provides & owns the actual physical last-mile connectivity medium. Some example services include cable TV service from a local cable provider to the end-user's area, telecom services from the local telecom provider, etc. Therefore, a drawback of the current implementations is that a user desiring to access a niche variety of programs or services must directly connect to a plurality of service providers who offer them. Oftentimes this is not possible due to the fact that the particular niche service provider lacks last-mile coverage in the user's area. For example, a user desires to see a entertainment channel from another continent in his regional language. If, however, that channel is not currently being provided by the local cable provider, the user must first find and connect directly (e.g., via satellite) if coverage exists at all over the user's area and only afterwards can connect through the television set to order and view the particular content.

To these days, there is no service provider that allows the user to access a diversity of media services from different service providers through a single, integrated, and, convivial interface regrouping access to more than just one type of media service or provider.

Content & service providers, tend to be specialized in the provision of information to a specific type or subject, while having limited coverage/accessibility to the end-users on a global scope. The development and implementation of physical content or service delivery infrastructure involves heavy development and financial burden on the involved companies. Therefore, once started, these companies are oftentimes reluctant to expand to fewer areas with low user densities.

Even in case a service provider the certain type of content or service that the end-users required, the end-user would not be able to choose the content or service providers of his choice as only the local service provider provides the infrastructure on which actual content is delivered. As a consequence of this, a effective service monopoly is created at the level of the end-user.

It would be useful to have content & service neutral media delivery method using an widely deployed yet effective medium such as broadband access to a public IP network for delivery of various types of multimedia content to the end-user from wide variety of service provider herein called virtual service providers. It would be also practical to have a media or service delivery model that avoids the dependency on any dedicated transmission infrastructure owned by any single service provider reaching the end-users, including at the level of the service provider. Furthermore, it would be convenient to provide the end-user with increased flexibility for accessing and viewing, or listening to, the various types selected programs from various virtual service providers from all around the world independent of their physical location or coverage.

What is needed is a system and method for addressing these issues and others that will become apparent in reading the following disclosure.

### SUMMARY OF THE INVENTION

There is a need to deliver access to local language TV and regional news print to the remote communities based in other countries. Particularly the delivery of channels in regional language, news from regional language newspapers, makes it convenient to transport them virtually to the end-user without depending on a direct physical last-mile link from the content provider itself.

According to one aspect of the present invention, a method and system is described for delivery of various media/services transparently to end-user by “Virtual Service Providers” over IP/Internet. A user's appliances are connected to a “Media Exchange Terminal” which provides media or services through a public IP Network, such as for example via an Internet HTTP (Hyper Text Transfer Protocol). The virtual service provider is in turn connected to one or more content sources, in which content providers each comprise at least one given type of media or service, such as for example video, audio, music, telephony, etc.

According another aspect of the invention, the end-user first connects his/her appliances to media exchange terminal for connectivity to the content providers, such as for example television to access cable content through the virtual service provider, and selects for viewing a given program from media exchange terminal. The media exchange terminal connects to the virtual service provider using a IP tunnel, virtual media exchange network exists when at least one virtual service provider is active. The virtual service provider further is connected to the content sources. The virtual service provider links both the media exchange terminal and the content source using IP tunnels over public IP network, during which the content is transferred transparently from the content provider to the media exchange terminal, and executed on the end-user's appliance.

According to yet another aspect of the present invention, a content independent virtual media transfer network is provided. The virtual media transfer network includes a virtual service provider connected to a plurality of content sources.

According to yet another aspect of the present invention, a method of performing media transmission from a Virtual Media Exchange Network is described. The method comprises the steps of: a) connecting to the virtual media exchange network using a IP tunnel, selecting a virtual service provider from a known service directory lookup service, comprising a content and service list including a plurality of selected virtual service provider; b) selecting the desired content gateway and service from the availability list; c) establishing a connection to the content gateway and service upon selection of content, streaming from the content gateway or server data to the media exchange terminal; and d) selecting the appliance connected to media exchange terminal for output depending upon the content type.

Various embodiments may include one or more of the following advantages. The digital media exchange aggregation gateway, virtual media exchange network and media exchange terminal described above are designed to convert audio and video data into transportable electronic format via encoding for deliver as streaming data to media exchange terminal users. Unlike the normal media dependent physical connectivity which uses a dedicated transmission medium to support transfer to appliance, systems and techniques described here provide a content neutral and provider independent transparent network access facility that permits the distribution and access of various media across different, independent providers. Such virtual media exchange network can be scaled more easily to accommodate large numbers of users globally.

Other features and advantages will be readily apparent from the following detailed description, the accompanying drawings, and the claims.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1.a (Prior Art) is a high-level block diagram of a typical prior art scenario for delivery of cable TV or video-on-demand;

FIG. 1.b (Prior Art) is a high-level flowchart diagram illustrative of the typical prior art method for delivering telecom services to telephone;

FIG. 2.a (Prior Art) is a high-level flowchart diagram illustrative of the typical prior art method for delivering telecom data service to fax printer;

FIG. 2.b (Prior Art) is a high-level block diagram of a typical prior art scenario for delivery of audio content via radio transmission;

FIG. 3.a (Prior Art) is a high-level flowchart diagram illustrative of the typical prior art method for delivering VoIP service to VoIP Phone;

FIG. 3.b (Prior Art) is a high-level block diagram of a typical prior art scenario for delivery of audio content via internet to internet terminal;

FIG. 4 is an exemplary high-level network diagram of the preferred embodiment of the present invention;

FIG. 5 illustrates a digital media exchange aggregation gateway arranged in accordance with the present invention;

FIG. 6 illustrates a embodiment of a media exchange terminal arranged in accordance with the present invention;

FIG. 7.A illustrates an exemplary network architecture that provides a virtual media exchange network consisting of tunnel;

FIG. 7.B is a more detailed logical block diagram of virtual media exchange network within the network architecture depicted in FIG. 7.A.;

FIG. 8 is a flow chart showing how content or data stream is provided from a virtual service provider to the user of a media exchange terminal connected via broadband internet;

FIG. 9 is an addressing scheme used with virtual service providers and media exchange terminals connected to virtual media exchange network; and

FIGS. 10A and 10B illustrate exemplary addressing configurations that can be used in the present techniques.

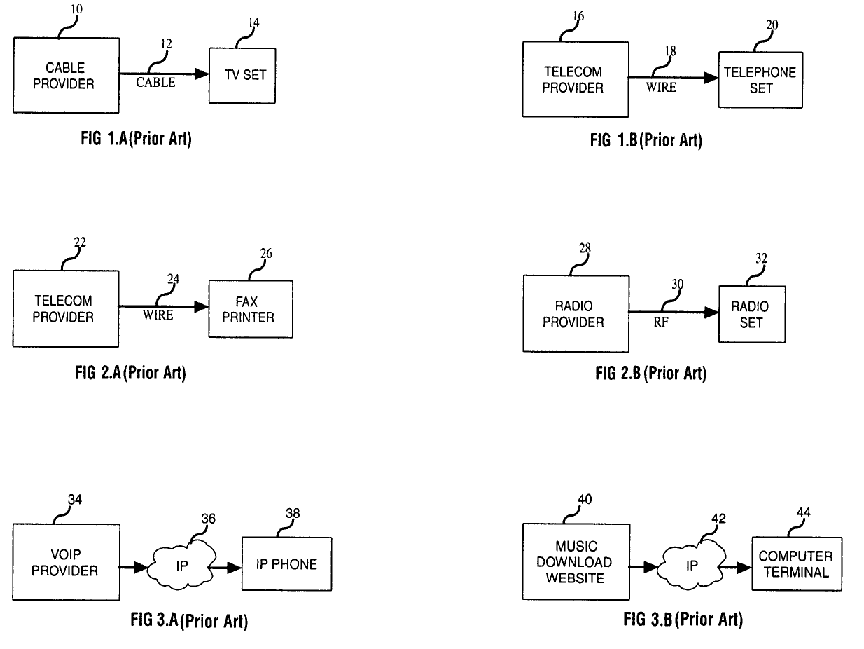

### DETAILED DESCRIPTION OF THE INVENTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

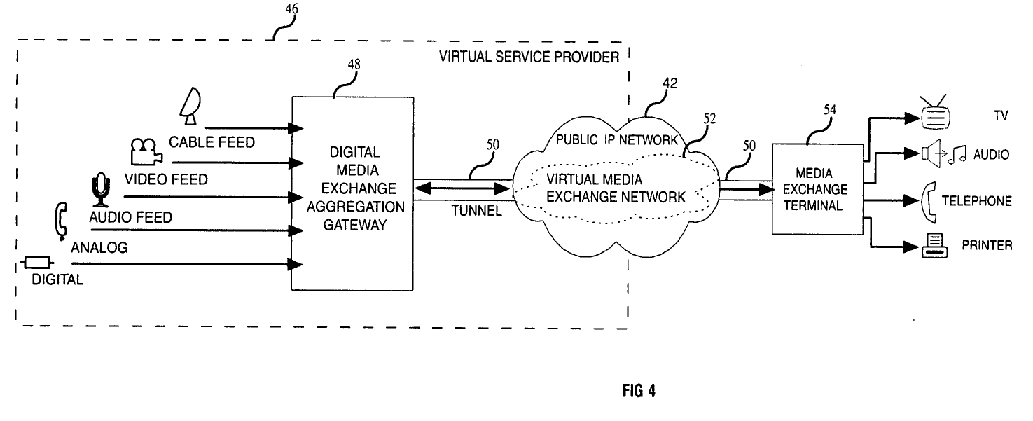

FIG. 4 illustrates a system that allows media neutral and provider independent transparent transmissions to be provided from a virtual service provider 46 and distribution network 52 to one or more tunneled media exchange terminals 54, through one or more public IP network access facilities 42. The digital media exchange aggregation gateway 48 serves as a gateway for media, and the media exchange aggregation gateway serves as encoder for input media to be placed on the virtual media exchange network 52. In this context, “virtual media exchange network” refers to a common private tunneled network that exists between one or more digital media exchange aggregation gateways 48 and node terminals 54.

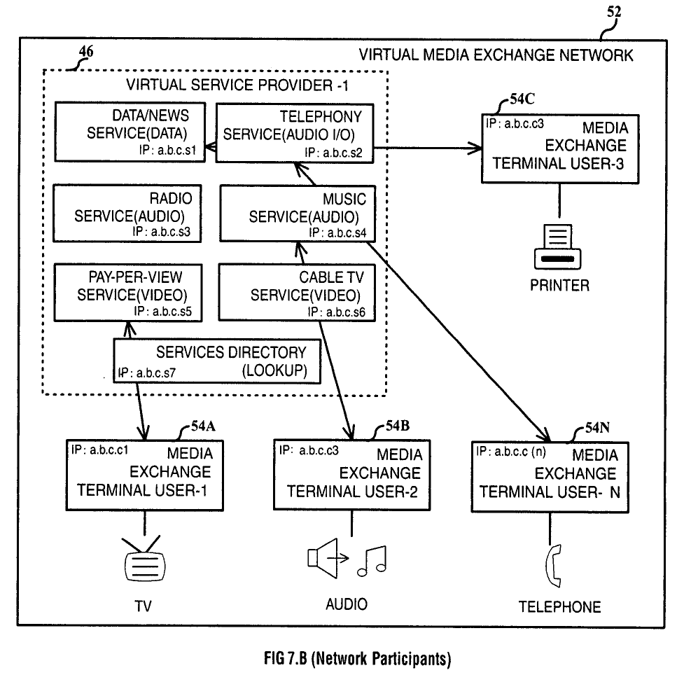

The virtual service provider 46 further comprises, or is connected to (the later detailed scenario being illustrated in FIG. 7A & FIG. 7B), a digital media exchange aggregation gateway 48 which interfaces with various media sources, the digital media exchange aggregation gateway 48 can have multiple host computers, servers and encoders for gathering and processing various types of information including data streams. For example, the digital media exchange aggregation gateway 48 typically obtains video, audio, encoded and placed on to as a unique service in the virtual media exchange network. Such programs may include, for example, tv channels streams, talk and music radio streams, interactive telephony access, full-length movies, electronic news papers streams, audio books, and conferences, among others. The digital media exchange aggregation gateway 48 can be coupled to the virtual media exchange network 52 by another public IP network 42 such as an Internet or a wide area network (WAN). Public IP network (Internet) interconnections 42, for example, can connect the virtual media exchange network 52 to the various public and private networks. The virtual media exchange network 52 is accessible to connected media exchange terminals 54 on network such as the Internet 42.

The virtual media exchange network 52, acts as a peering point, in other words, a network traffic exchange facility through which disparate, independent end-users can exchange Internet protocol (IP) data streams. It provides a common point to which a virtual service providers stream data can be linked or exchanged to assure delivery of digital streaming media or services to all end-users media exchange terminals 54 requesting receipt of a transmission.

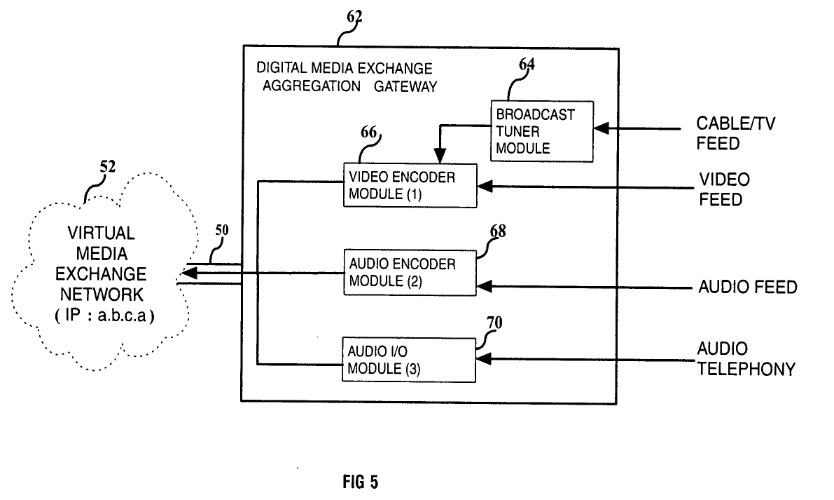

FIG. 5 illustrates various components of an exemplary digital media exchange aggregation gateway 62. Digital media exchange aggregation gateway consists of media encoders for each type of media or service being delivered by the virtual service provider, these are 66,68 & 70. Media with different format is converted to one of the basic types using conversion module such as 64. Communication links 50 associated, for example, with public internet backbone providers connect the virtual media exchange network 52 using a IP tunnel 50 to virtual media exchange network or via either direct interconnections or virtual private network (VPN) connections. The Digital media exchange aggregation gateway 62 includes various networking equipment, including multiplexers to which the media sources are coupled.

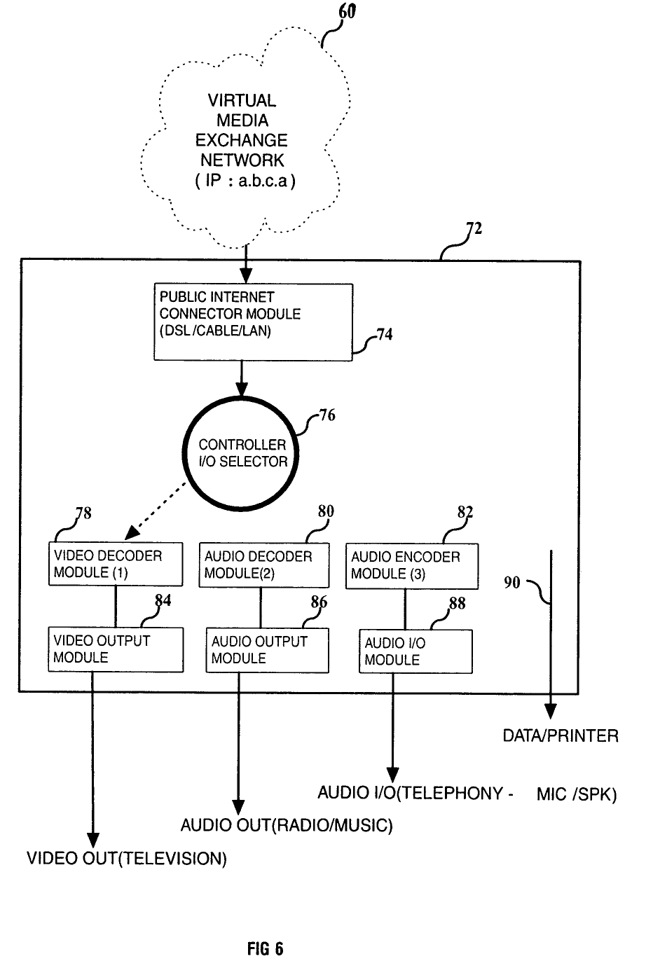

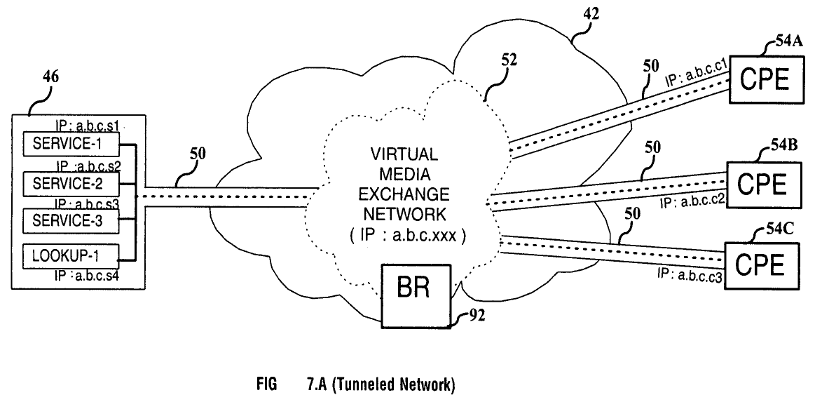

Reference is now made to FIG. 6, media exchange terminal arranged in accordance with embodiment of the invention. In FIG. 6, terminal 72 is an virtual media exchange network client and communicates with virtual service provider 46 over the virtual media exchange network 52, using an IP tunnel connection 50 and connectivity to public IP network such as Internet. Media exchange terminal 72 receives data streams of the selected service from the plurality of the virtual service provider 46 and selects appropriate decoder to use upon the type of service using controller 76. Upon receipt of the content from controller 76 the data stream is passed for each type of media or service being delivered to the decoders; these are 78, 80 & 82. The decoded data is further converted to analog audio, video signals using output modules 84,86 and 88 for output to the appliances attached which is selected for output.

FIG. 7A network architecture that provides a virtual media exchange network consisting of participation from at least one virtual service provider 46 and one or more end-user media exchange terminals 54A, 54B, 54C, connected via IP tunnels to the virtual media exchange network 52 that is facilitated by a existing internet router 90, and FIG. 7B illustrates the logical block diagram within the virtual media exchange network 52 which facilitates the exchange and transmission of media from the virtual service providers, such as 46 to end-users such as 54A54B,54C,54(n).

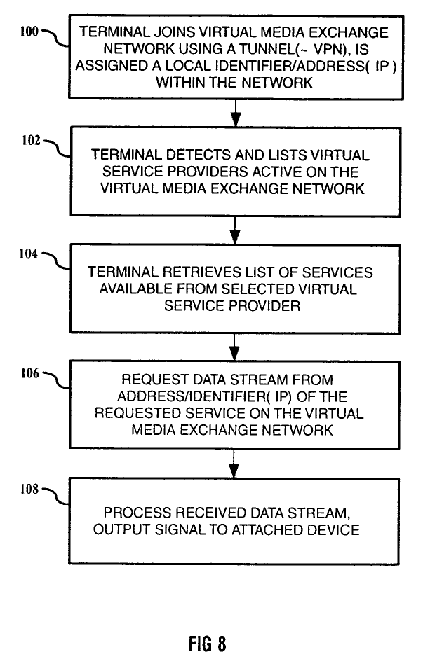

FIG. 8 illustrate how content or data stream is provided to the user of media exchange terminal, such as the client media exchange terminal 54A, connected to a virtual media exchange network, such as the network 52. As illustrated in FIG. 7A, the virtual media exchange network 52 connects multiple media exchange terminals such as 54A, 54B, 54C and virtual service provider such as 46. To request a video, audio or other data streams, the user's terminal 54 connects to virtual media exchange network using a tunnel and upon connecting terminal is assigned a local address/ip within the virtual media network (block 100). In this context, the assigned address or identification scheme is either in IPv6 (preferred) which is more suited for this implementation used in the present techniques or backward compatible IPv4 which would restrict the scalability for maximum numbers of users that can connect to virtual media exchange network. The user typically would use a client such as media exchange terminal connected to a public IP network such as internet. The terminal 54 after joining the virtual media exchange network attempts to discovers virtual service providers connected to the virtual media exchange network (block 102). Upon default selection of a virtual service provider by the terminal or manually select by the user the media exchange terminal constructs a list of active services or content streams available from the selected virtual service provider, this is done by discovering active services in the same address range of that virtual service provider (block 104). In other words, a list of available services is built by the media exchange terminal 54 that can be connected for receiving content or data stream from the selected virtual service provider 46 over the virtual media exchange network 52 which constitute the path over which the requested media will be sent is established. The terminal selects a content or media services from the availability list or manually selected by the user, the terminal establishes a connection with the corresponding address of the requested service from the virtual service provider connected to virtual media exchange network (block 106). The requested data stream is received by the media exchange terminal 54 from the selected service (address) of the virtual service provider 46 through the virtual media exchange network is converted/decoded back to analog signal appropriately for output to attached appliances with the user's media exchanger terminal (block 108).

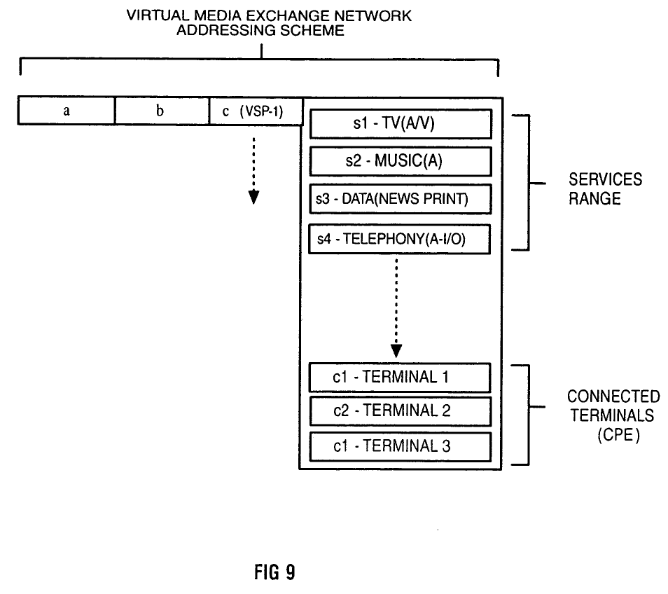

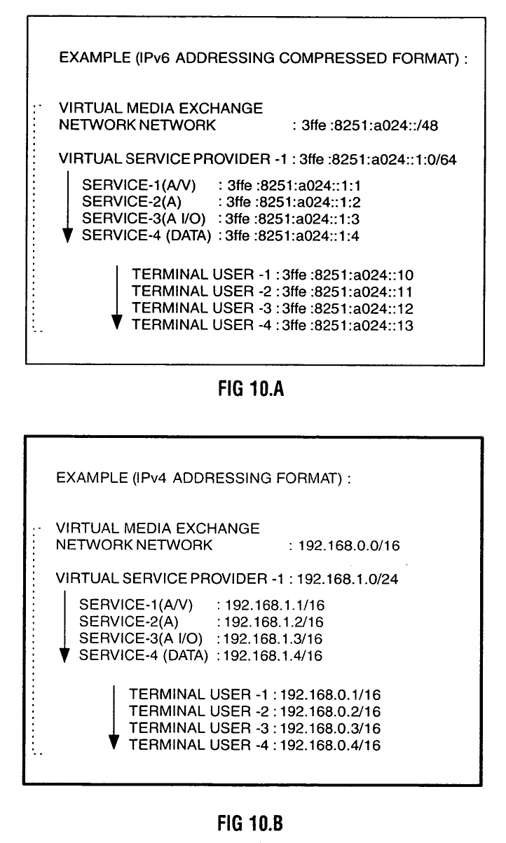

FIG. 9 explains further details of how addressing scheme within the virtual media exchange network 52 is allocated. When the media exchange terminal 54 joins the virtual media exchange network using IP tunnel 50 it is allocated a unique address within the virtual media exchange network, the virtual service providers are clustered into a logically serial block to facilitate media exchanged terminal to automatically discovery active virtual service providers and their associated available services. In particular, FIGS. 10A and 10B illustrate exemplary configurations of addressing that can be used in the techniques described here.

FIG. 10A indicates IP address configuration for a virtual media exchange network using a IPv6 compressed addressing format in which the subnet of the virtual media exchange network contains both the virtual service providers, services available and media exchange terminal users, IPv6 addressing provides to be the most advantageous for the deployment of such a virtual media exchange used in the techniques described here due to the potential size of network derived from it being 65,535 subnets * 2\hat{ }64 maximum possible participant nodes. FIG. 10B indicates IP address configuration for a virtual media exchange network using existing IPv4 addressing format also in which the subnet of the virtual media exchange network contains both the virtual service providers, services available and media exchange terminal nodes.

What has been described above includes a method of establishing a media independent virtual media delivery & exchange network over any Public IP Network or Internet for delivering media services such as audio, video & electronic content to end-users independent of actual media dependent last-mile physical connectivity in place. In one embodiment, the virtual media delivery & exchange network includes a central services directory lookup service.

According to one aspect of the present invention, a virtual media service provider comprises multiple content or services without provider owned direct last-mile infrastructure reaching the end-user; last-mile via the Internet; and a end-user appliance, wherein the end-user appliance is a normal non-internet aware output device.

According to another aspect of the present invention, a virtual media exchange network comprises at least one content broadcast or virtual service provider; and at least one Media exchange terminal, wherein the Media exchange terminal is arranged to connect to one of the virtual service providers & select content for output to a user's appliance. In one embodiment, the virtual media delivery & exchange network includes a central services directory lookup service.

According to yet another aspect of the present invention, a CPE/Media exchange terminal comprises an Ethernet port for broadband connection input; a video decoder module which using any of the standard codecs implementations such as mpeg4; an audio decoder module which uses any of standard codecs implementations such as vorbis; a video output module for output of S-Video to standard televisions; a audio output module for output to existing audio system; an audio line input & output which is used for telephony; a data output which is used for output device such as a printer; a Wi-Fi Access Point controller that makes the location into a hotspot, to deliver connectivity to other devices in that location; and a controller that selects the output method & device. The controller module is arranged to lookup a predefined service directory lookup service or server and initiates a connection to service server for output using one either the audio or video or both decoder output modules.

According to one embodiment of the present invention, the Media exchange terminal is preset by a virtual service provider so it only connects to the specific virtual service provider or to a specific media or service.

According to yet another aspect of the present invention, a method of customized television includes replacing a regular episode with a missed episode in place of the regular episode at the regular time. In one such embodiment, each user watches the same channel but receives different episodes of the same series. Customization is possible to each individual in a house as well.

According to yet another aspect of the present invention, a method of customized radio includes replacing a regular episode with a missed episode in place of the regular episode at the regular time. In one such embodiment, each user listens to the same channel but receives different episodes of the same series. Customization is possible to each individual in a house as well.

According to yet another aspect of the present invention, a method of authenticating e-com transactions includes providing a credit card reader on an IP phone and authenticating the e-com transactions by swiping the user's credit card for better security and fraud prevention.

According to another aspect of the present invention, a method is provided for delivering ethnic content for a specific customer who is away from home, wherein he at present does not have any content available. According to another aspect of the present invention, a method is described by which third party service providers can provide services to the customer and also interact with other devices in the premises through the wireless connectivity within the premises.

According to another aspect of the present invention, a method is provided for providing Movies and other special events on demand on the same day of theatre release or live, the method comprising modifying the stream to form an encrypted and watermarked stream, which can be used to identify the person from whose subscription the copy was made.

In general, digital media exchange aggregation gateway, virtual media exchange network and media exchange terminal described above are designed to convert audio and video data into electronic format via encoding for deliver as streaming data to media exchange terminal which are in-turn connected traditional non-internet aware appliances with the users. Unlike the normal media dependent physical connectivity which uses a dedicated transmission medium to support transfer of content to appliance, systems and techniques described here provide a content neutral and provider independent transparent network access facility that permits the distribution and access of various media across different, independent providers who can be spread geographically independent of the end-users physical location. Such virtual media exchange network can be scaled easily to accommodate large numbers of users globally.

This functionality can be used in a number of ways. For instance, this system and method can be used to provide Movies and other special events on demand on the same day of theatre release or live as described above. In addition, this system and method can be used to deliver exact or edited post script versions of newspapers printed in other countries, to be automatically printed on the subscribers' printers or can be viewed on their televisions.

This system and method can also be used to deliver custom specified advertising which can switch the running ad on a channel subscribed, according to the viewer background. If, for instance, a subscriber's info indicates he owns a Lexus car, during the time when a Lexus ad is running on the channel being watched, the system can switch in a different advertisement (e.g., a car ad for a car in the same category or a category above).

This system and method can also be used to deliver online matrimonial video clippings which can be seen only once by the authorized probable partner.

This system and method can also be used to deliver first day, first show video on demand. For instance, foreign films could be shown to niche markets in other countries as soon as they are released, which can eradicate the release of other country movies in theatre and cater to a much bigger audience, no matter where they stay.

In the above discussion, the term s “computer” and “terminal” are defined to include any digital or analog data processing unit. Examples include any personal computer, workstation, set top box, mainframe, server, supercomputer, laptop or personal digital assistant capable of embodying the inventions described herein.

Examples of articles comprising computer readable media are floppy disks, hard drives, CD-ROM or DVD media or any other read-write or read-only memory device.

Portions of the above description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

1. A method of establishing a media independent virtual media delivery & exchange network over any Public IP Network or Internet for delivering media services such as audio, video & electronic content to end-users independent of actual media dependent last-mile physical connectivity in place.

2. The method of claim 1 wherein said virtual media delivery & exchange network also comprises of a central services directory lookup service.

3. The method of claim 1 wherein said virtual media delivery & exchange network using IPv6 addressing scheme.

4. The method of claim 1 wherein said virtual media delivery & exchange network using IPv4 addressing scheme.

5. A virtual media service provider, comprising;
a media exchange aggregation gateway;
a media exchange terminal; and
a virtual media exchange network connected between the media exchange aggregation gateway and the media exchange terminal;
wherein the media exchange aggregation gateway aggregates content received from a plurality of content or services providers communicatively coupled to the media exchange aggregation gateway and wherein the media exchange terminal receives content from one or more of the content or services providers via the media exchange aggregation gateway.

6. The provider of claim 5, wherein the virtual media exchange network includes an IP tunnel.

7. The provider of claim 5, wherein the virtual media exchange network includes a virtual private network (VPN).

8. The method of claim 5 wherein the content received by the media exchange terminal includes content from two or more media services, wherein the media exchange terminal separates the content into two or more streams and delivers each stream to a different user appliance.

9. A virtual media exchange network comprising:
At least one content broadcast or virtual service provider; and
At least one CPE or Media exchange terminal, wherein the Media exchange terminal is arranged to connect to one of the virtual service providers & select content for output to a user's appliance.

10. The method of claim 9 wherein said virtual media exchange network also compromising of a central service directory lookup.

11. A CPE/Media exchange terminal, comprising:
an Ethernet port for broadband connection input; a video decoder module which using any of the standard codecs implementations such as mpeg4;
an audio decoder module which uses any of standard codecs implementations such as vorbis;
a video output module for output of S-Video to standard televisions;
an audio output module for output to existing audio system;
an audio line input & output which is used for telephony;
a data output which is used for output device such as a printer;
a Wi-Fi Access Point controller that makes the location into a hotspot, to deliver connectivity to other devices in that location;
a controller that selects the output method & device; and
wherein the controller module is arranged to lookup a predefined service directory lookup service or server and initiates a connection to service server for output using one either the audio or video or both decoder, output modules.

12. The method of claim 11 wherein said Media exchange terminal pre-arranged by a virtual service provider so it only connects to the specific virtual service provider or to a specific media or service.

13-22. (canceled)
